(19) United States
(12) Patent Application Publication
(10) Pub. No.: US 2023/0123151 A1
(43) Pub. Date: Apr. 20, 2023

(54) DATA TRANSMISSION METHOD AND DEVICE

(71) Applicant: Spreadtrum Communications (Shanghai) Co., Ltd., Shanghai (CN)

(72) Inventor: Yun Deng, Shanghai (CN)

(21) Appl. No.: 17/905,164

(22) PCT Filed: Feb. 5, 2021
(86) PCT No.: PCT/CN2021/075591

§ 371 Date: Aug. 26, 2022

(30) Foreign Application Priority Data
Feb. 26, 2020 (CN) 202010121574.X

(51) Int. Cl. H04W 74/00; H04W 74/08; H04W 76/27; H04L 5/00

(52) U.S. Cl. CPC H04W 74/008; H04L 5/0048; H04W 74/0833; H04W 76/27

(57) ABSTRACT

A data transmission method is provided by embodiments of the present disclosure. When a UE is in an idle state or an inactive state, if data which needs to be transmitted has been generated in the UE, the quantity of bits of the data to be transmitted in the UE is determined; then a target transmission mode corresponding to the quantity of bits is determined based on transmission configuration information; and the data to be transmitted is transmitted based on the target transmission mode; where the target transmission mode includes any one of the following modes: performing data transmission by the UE based on a random access procedure, performing data transmission by the UE based on a transmission resource pre-configured by a network device, or performing data transmission by the UE after transitioning to a connected state.

### CROSS-REFERENCE TO RELATED APPLICATION

This application is a National Stage of International Application PCT/CN2021/075591, filed on Feb. 5, 2021, which claims priority to Chinese Patent Application No. 202010121574.X, filed with the China National Intellectual Property Administration on Feb. 26, 2020, both of which are incorporated by reference herein.

### TECHNICAL FIELD

Embodiments of the present disclosure relate to the field of mobile communication technologies and in particular, to a data transmission method and device.

### BACKGROUND

In a long term evolution (LTE) system, when a user equipment (UE) has a requirement of a data service, the user equipment accesses a wireless network to establish a radio resource control (RRC) connection and establish a dedicated data radio bearer (DRB) so as to transmit data. After a UE enters a connected state (connected), a network device allocates necessary configuration parameters to the UE for data transmission. After the UE completes the data transmission, the UE enters an idle state (idle) from the connected state, and then the network device releases all configuration parameters of the UE after the UE enters the idle state. If the UE wants to establish a data service again, the network device reallocates configuration parameters to the UE.

In practical applications, some UEs will transmit data many times within a period of time, and for this type of service requirement, if the transmission mechanism described above is used, an RRC connection needs to be established for each data transmission, and the RRC connection is released after the data transmission ends. When the UE transmits data repeatedly for many times, a large amount of signaling interaction is inevitably caused, so that the signaling load of the network device is excessively heavy, and the efficiency of data transmission is reduced.

### SUMMARY

In a first aspect, embodiments of the present disclosure provide a data transmission method, applied to a UE, where the UE is in an idle state or an inactive state, and the method includes:
determining the quantity of bits of data to be transmitted in the UE;
determining a target transmission mode corresponding to the quantity of bits based on transmission configuration information, where the target transmission mode includes any one of the following modes: performing data transmission by the UE based on a random access procedure, performing data transmission by the UE based on a transmission resource pre-configured by a network device, or performing data transmission by the UE after transitioning to a connected state; and
transmitting the data to be transmitted based on the target transmission mode.

In a second aspect, embodiments of the present disclosure provide a data transmission method, applied to a UE, where the UE is in an idle state or an inactive state, and the method includes:
determining whether a transmission resource pre-configured by a network device in transmission configuration information satisfies a pre-set transmission condition;
when the pre-configured transmission resource satisfies the pre-set transmission condition, transmitting, by the UE, data to be transmitted based on the transmission resource pre-configured by the network device; and
when the pre-configured transmission resource does not satisfy the pre-set transmission condition, determining, by the UE, the quantity of bits of the data to be transmitted; when the quantity of bits is smaller than a first threshold, transmitting, by the UE, the data to be transmitted based on a random access procedure; and when the quantity of bits is greater than or equal to the first threshold, transmitting, by the UE, the data to be transmitted after transitioning to a connected state.

In a third aspect, embodiments of the present disclosure provide a data transmission method, applied to a UE, where the UE is in an idle state or an inactive state, and the method includes:
determining a quantity of bits of data to be transmitted in the UE;
determining whether the quantity of bits of the data to be transmitted is smaller than a second threshold and whether a pre-configured transmission resource satisfies a pre-set transmission condition; and
when the quantity of bits of the data to be transmitted is smaller than the second threshold, and the pre-configured transmission resource satisfies the pre-set transmission condition, performing data transmission based on the pre-configured transmission resource;
where the pre-set transmission condition includes at least one of: a serving cell corresponding to the pre-configured transmission resource being a serving cell where the UE currently resides, or, signal quality of one or more beams corresponding to the pre-configured transmission resource exceeding a pre-set threshold.

In a fourth aspect, embodiments of the present disclosure provide a user equipment, including: at least one processor and a memory;
the memory stores computer execution instructions; and
the at least one processor executes the computer execution instructions stored in the memory to cause the at least one processor to execute the data transmission method according to the first aspect.

In a fifth aspect, embodiments of the present disclosure provide a user equipment, including: at least one processor and a memory;
the memory stores computer execution instructions; and
the at least one processor executes the computer execution instructions stored in the memory to cause the at least one processor to execute the data transmission method according to the third aspect.

In a sixth aspect, embodiments of the present disclosure provide a non-transitory computer readable storage medium, where the computer readable storage medium stores computer execution instructions therein, and when a processor executes the computer execution instructions, the data transmission method according to the second aspect is implemented.

### BRIEF DESCRIPTION OF DRAWINGS

To describe technical solutions of the present disclosure or in the prior art more clearly, the following briefly introduces accompanying drawings required for describing the embodiments or the prior art. Apparently, the accompanying drawings in the following description show merely some embodiments of the present disclosure, and a person of ordinary skill in the art may still derive other drawings from these accompanying drawings without creative efforts.

FIG. 1 is a schematic diagram of an architecture of a wireless communication system provided by an embodiment of the present disclosure;

FIG. 2 is a first signaling diagram of state transition in a data transmission method provided by an embodiment of the present disclosure;

FIG. 3 is a second signaling diagram of state transition in a data transmission method provided by an embodiment of the present disclosure;

FIG. 4 is a first schematic flowchart of a data transmission method provided by an embodiment of the present disclosure;

FIG. 5 is a second schematic flowchart of a data transmission method provided by an embodiment of the present disclosure;

FIG. 6 is a third schematic flowchart of a data transmission method provided by an embodiment of the present disclosure;

FIG. 7 is a fourth schematic flowchart of a data transmission method provided by an embodiment of the present disclosure;

FIG. 8 is a fifth schematic flowchart of a data transmission method provided by an embodiment of the present disclosure;

FIG. 9 is a sixth schematic flowchart of a data transmission method provided by an embodiment of the present disclosure;

FIG. 10 is a seventh schematic flowchart of a data transmission method provided by an embodiment of the present disclosure;

FIG. 11 is a schematic diagram of signaling interaction of a data transmission method provided by an embodiment of the present disclosure;

FIG. 12 is a first schematic diagram of program modules of a data transmission apparatus provided by an embodiment of the present disclosure;

FIG. 13 is a second schematic diagram of program modules of a data transmission apparatus provided by an embodiment of the present disclosure; and

FIG. 14 is a schematic structural diagram of hardware of an electronic device provided by an embodiment of the present disclosure.

### DESCRIPTION OF EMBODIMENTS

To make objectives, technical solutions, and advantages of the present disclosure clearer, the technical solutions in the embodiments of the present disclosure are clearly and completely described in the following with reference to the accompanying drawings in the embodiments of the present disclosure. Apparently, the embodiments to be described are merely a part rather than all of the embodiments of the present disclosure. All other embodiments obtained by those of ordinary skill in the art based on the embodiments of the present disclosure without any creative effort fall within the protection scope of the present disclosure.

The embodiments of the present disclosure may be applied to various communication systems, for example, an advanced long term evolution (LTE-A) system, a new radio (NR) system, an evolved system of the NR system, and an LTE-based access to unlicensed spectrum (LTE-U) system, an NR-based access to unlicensed spectrum (NR-U) system, a universal mobile telecommunication system (UMTS), wireless local area networks (WLAN), wireless fidelity (WiFi), a next generation communication system or other communication systems, etc.

Generally, a traditional communication system supports a limited quantity of connections and is easy to implement. However, with the development of communication technologies, a mobile communication system will not only support traditional communication, but also support, for example, device to device (D2D) communication, machine to machine (M2M) communication, machine type communication (MTC), and vehicle to vehicle (V2V) communication. The embodiments of the present disclosure may also be applied to these communication systems.

In an embodiment, the communication system in the embodiments of the present disclosure may be applied to a carrier aggregation (CA) scenario, may also be applied to a dual connectivity (DC) scenario, and may also be applied to a standalone (Standalone, SA) network deployment scenario.

The embodiments of the present disclosure do not put a limitation on the spectrum applied. For example, the embodiments of the present disclosure can be applied to a licensed spectrum, and can also be applied to an unlicensed spectrum.

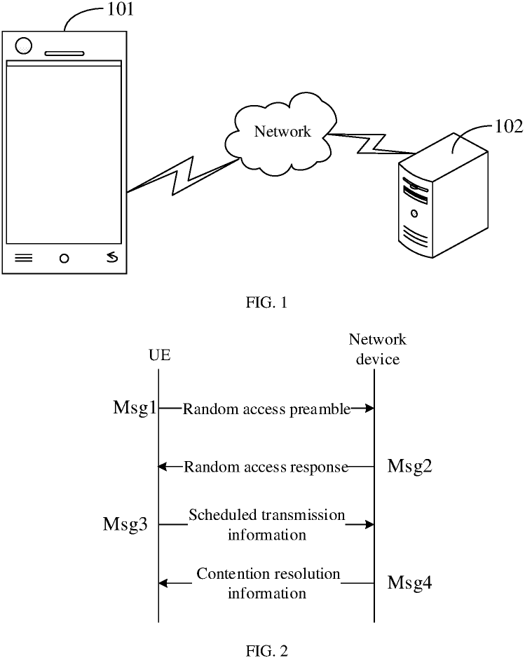

Referring to FIG. 1, FIG. 1 is a schematic diagram of an architecture of a wireless communication system provided by an embodiment of the present disclosure. The wireless communication system provided by the embodiment includes a UE 101 and a network device 102.

In an embodiment, the UE 101 may refer to various forms of user equipment, access terminals, subscriber units, subscriber stations, mobile sites, mobile stations (MS), remote stations, remote terminals, mobile devices, terminal equipment, wireless communication devices, user agents, or user apparatuses. The UE 101 may also be a cellular telephone, a cordless telephone, a session initiation protocol (SIP) phone, a wireless local loop (WLL) station, a personal digital assistant (PDA), a handheld device having a wireless communication function, a computing device or other processing devices connected to a wireless modem, an in-vehicle device, a wearable device, a terminal device in a future 5G network or a terminal device in a future evolved public land mobile network (PLMN), etc. The embodiments of the present disclosure are not limited thereto, as long as the UE 101 can wirelessly communicate with the network device 102.

In the embodiments of the present disclosure, a unidirectional communication link from an access network to a UE is defined as a downlink, data transmitted on the downlink is downlink data, and a transmission direction of the downlink data is referred to as a downlink direction; while a unidirectional communication link from the UE to the access network is an uplink, data transmitted on the uplink is uplink data, and a transmission direction of the uplink data is referred to as an uplink direction.

In an embodiment, the network device 102 is a public mobile communication network device, is an interface device for the UE 101 to access the Internet, and is also a form of a radio station, which refers to a radio transceiving station for transferring information with the UE 101 in a certain radio coverage area, including a base station (Base Station, BS), also referred to as a base station device, which is an apparatus deployed in a radio access network (Radio Access Network, RAN) to provide wireless communication capability. For example, a device providing a function of the base station in a 2G network includes a base transceiver station (BTS), a device providing the function of the base station in a 3G network includes a NodeB, and a device providing the function of the base station in a 4G network includes an evolved NodeB (eNB), a device providing the function of the base station in wireless local area networks (WLAN) is an access point (AP), a device providing the function of the base station in 5G NR includes a gNB and a continuously evolved node B (ng-eNB), where an NR technology is adopted for communications between the gNB and the UE, and an evolved universal terrestrial radio access (E-UTRA) technology is adopted for communications between the ng-eNB and the UE. Both the gNB and the ng-eNB may be connected to a 5G core network. The network device 102 in the embodiments of the present disclosure further includes a device which provides a function of a base station in a future new communication system, etc.

In a feasible implementation, the network device may send uplink scheduling information (UL Grant) to the UE by using downlink control information (DCI), to indicate a physical uplink shared channel (PUSCH) transmission, so that the UE can send data.

In an embodiment, the UL grant may include the following information:
information of resource allocation (Resource block assignment and hopping resource allocation);
information of modulation and coding scheme and redundancy version, which is used for specifying a modulation and coding scheme (MCS) and a redundancy version (RV) of a corresponding PUSCH transmission, and for determining a transmission block size (TB size);
information of a new data indicator, which is used for determining whether a current transmission is a new transmission or a retransmission;
a TPC command for scheduling the PUSCH, which is used for power control of the PUSCH;
an HARQ process number, which is used for specifying an HARQ process corresponding to a current transmission.

In addition, there are generally two types of pre-configured/ semi-persistent resource (configured grant resource) configuration modes for uplink transmission.

Pre-configured (pre-grant) mode 1: configuration (IE Configured Grant Config) is performed through radio resource control (Radio Resource Control, RRC) layer signaling.

Pre-configured (pre-grant) mode 2: the activation and deactivation of an uplink pre-configured /semi-persistent resource is indicated by DCI, and a part of required configuration parameters is configured in advance in the IE Configured Grant Config through RRC signaling by a network device, but can be used only after activated by the DCI.

In an embodiment, the embodiments of the present disclosure may be applied to various periodic services, and the network device may configure a periodic transmission resource for the UE through a semi-persistent scheduling (Semi-Persistent Scheduling, SPS) mode or a pre-configured/pre-grant (Configured Grant, CG) mode.

In an embodiment, the embodiments of the present disclosure can may be applied to aperiodic services.

In a communication system where carrier aggregation is introduced, an aggregated carrier is referred to as a component carrier (CC), and is also referred to as a serving cell, which includes a primary component carrier/cell (PCC/PCell) and a secondary component carrier/cell (SCC/SCell). The communication system performing carrier aggregation at least includes one primary serving cell and a secondary serving cell, where the primary serving cell is always in an active state.

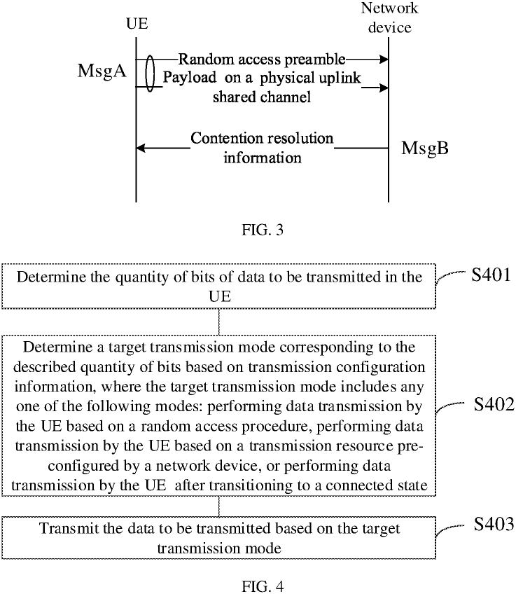

In the embodiments of the present disclosure, when the UE is in an idle state or an inactive state, if data transmission needs to be initiated, a random access procedure needs to be performed to transition to a connected state. Specifically, reference may be made to FIG. 2, which is a first schematic signaling diagram of state transition in a data transmission method provided by an embodiment of the present disclosure. In the embodiment of the present disclosure, a process of the UE transitioning from the idle state or the inactive state to the connected state includes:
a first step: the UE selects an SSB or a CSI-RS from primary and secondary synchronization signal (SS)/physical broadcast channel (PBCH) resource blocks (also abbreviated as SSBs) or channel state information reference signals (CSI-RS) of a cell which satisfy a condition, then selects a preamble, and sends a random access preamble, i.e., Msg1: Random Access Preamble, on a time-frequency resource which is allowed to be initiated;
a second step: the UE receives a random access response, i.e., Msg2: Random Access Response, which contains TA information (Timing Advance), sent by the network device;
a third step: the UE sends scheduled transmission information, i.e., Msg3: Scheduled Transmission, by using the grant received in the Msg2; and
a fourth step: if the UE receives contention resolution information, i.e., Msg4: Contention Resolution, then it is considered that the contention resolution is successful, and the random access procedure is successful; and if the scheduling from the base station is not received within a certain period of time, it is considered that the contention resolution fails.

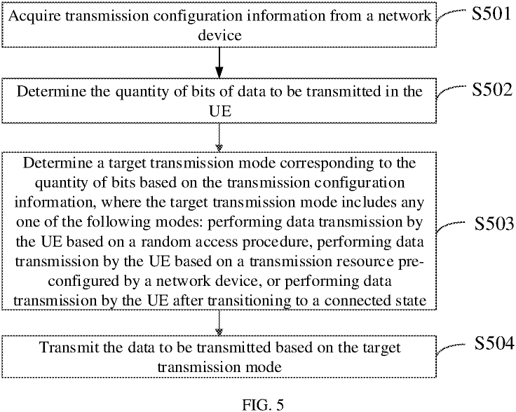

In order to accelerate the random access procedure, reduce the time delay and reduce the quantity of messages, it is proposed to use a two-step random access procedure. For details, reference can be made to FIG. 3. FIG. 3 is a second schematic signaling diagram of state transition in a data transmission method provided by an embodiment of the present disclosure.

In FIG. 3, MsgA includes original Msg1 and Msg3 information, that is, includes a preamble sent on a physical random access channel (PRACH) and a payload portion sent on a physical uplink shared channel (PUSCH); and MsgB includes Msg2 and Msg4 information.

In a 5G new radio system, after completing data transmission, the UE does not enter the idle state, but enters a new state, i.e., an inactive state. After entering the inactive state, the UE does not perform data transmission with the network device, but periodically receives a paging. Both the network device and the UE keep the configuration parameters allocated to the UE. When the UE has data to be transmitted, the UE can use the stored configuration parameters to enter the connected state quickly to perform data transmission, thereby improving the efficiency of the data transmission. In the embodiments of the present disclosure, in order to send data in a disconnected state, in addition to sending an RRC message in the Msg3 or the MsgA, data to be transmitted may also be carried for transmission; or only the data to be transmitted of the UE and identification information of the UE are carried in the Msg3 or MsgA.

That is, for the UE in the idle state or the inactive state, if the data to be transmitted is generated in the UE, there may exist the following three data transmission modes. Mode 1: the UE carries the data in the MsgA sent by the UE in the two-step random access procedure or in the Msg3 sent by the UE in the four-step random access procedure for transmission. Mode 2: the UE performs data transmission based on a transmission resource pre-configured by the network device. Mode 3: the UE performs data transmission after transitioning to the connected state. However, at present, there is no solution capable of reasonably selecting an appropriate data transmission mode.

In order to solve the described technical problem, the embodiments of the present disclosure provide a data transmission method. When the UE is in the idle state or the inactive state, if the data to be transmitted is generated in the UE, the quantity of bits of the data to be transmitted in the UE is determined; then a target transmission mode corresponding to the quantity of bits is determined based on transmission configuration information, and the data to be transmitted is transmitted based on the target transmission mode. Since the amount of data which is transmitted during the random access procedure is generally small, the amount of data which is transmitted based on the transmission resource pre-configured by the network device depends on the size of the pre-configured resource, while the amount of data which is transmitted after the UE transitions to the connected state is generally not limited, therefore, when the UE is in the idle state or the inactive state, and there exists data which needs to be transmitted, taking the quantity of bits of the data to be transmitted as a basis can facilitate the UE selecting an appropriate data transmission mode.

Based on the described theory, embodiments of the present disclosure propose a data transmission method. Referring to FIG. 4, FIG. 4 is a first schematic flowchart of a data transmission method provided by an embodiment of the present disclosure, and an execution body of the embodiment is a UE in the embodiment shown in FIG. 1. As shown in FIG. 4, the method includes the following.

S401: determine the quantity of bits of data to be transmitted in the UE.

In the embodiment of the present disclosure, before the UE enters an idle state or an inactive state, a network device may pre-configure a transmission resource (Pre-configured PUSCH resources, PUR) on a PUSCH for the UE. When the UE is in the idle state or the inactive state, if it is detected that data to be transmitted is generated in the UE, the quantity of bits of the data to be transmitted in the UE is determined. The UE determines the quantity of bits of the data to be transmitted, which belongs to an implementation of the UE, and may have different implementations. For example, the UE determines the data to be transmitted which is submitted by an application layer to an access layer, or the access layer of the UE determines the quantity of bits of the data to be transmitted.

S402: determine a target transmission mode corresponding to the described quantity of bits based on transmission configuration information, where the target transmission mode includes any one of the following modes: performing data transmission by the UE based on a random access procedure, performing data transmission by the UE based on a transmission resource pre-configured by a network device, or performing data transmission by the UE after transitioning to a connected state.

In the embodiment of the present disclosure, the UE can determine, based on a data transmission mechanism configured on the UE itself or indication information sent from the network device, the described transmission configuration information, and the transmission configuration information includes transmission modes corresponding to quantities of bits in respective value ranges.

After determining the quantity of bits of the data to be transmitted, the UE may determine, based on the transmission configuration information, the target transmission mode corresponding to the quantity of bits of the data to be transmitted.

For example, assuming that when the quantity of bits in the transmission configuration information is less than 200 bits, the UE performs data transmission based on the random access procedure; when the quantity of bits is more than or equal to 200 bits and less than 1000 bits, the UE performs data transmission based on the transmission resource pre-configured by the network device; and when the quantity of bits is more than or equal to 1000 bits, the UE performs data transmission after transitioning to the connected state. If the UE determines that the quantity of bits of the data to be transmitted is 800 bits, then it can be determined that the target transmission mode is performing data transmission by the UE based on the transmission resource pre-configured by the network device.

S403: transmit the data to be transmitted based on the target transmission mode.

In the embodiment of the present disclosure, when the target transmission mode is performing data transmission by the UE based on the random access procedure, the UE can carry the data to be transmitted in an MsgA sent by the UE in a two-step random access procedure or in an Msg3 sent by the UE in a four-step random access procedure to send the same to the network device. When the target transmission mode is performing data transmission by the UE based on the transmission resource pre-configured by the network device, the UE carries the data to be transmitted on the pre-configured transmission resource to send the same to the network device. When the target transmission mode is performing data transmission by the UE after transitioning to the connected state, the UE first transitions from the idle state or the inactive state to the connected state, and then sends the data to be transmitted to the network device through an established connection.

In the data transmission method provided by the embodiment of the present disclosure, when the UE is in the idle state or in the inactive state, if data which needs to be transmitted is generated in the UE, the quantity of bits of the data to be transmitted in the UE is determined; then the target transmission mode corresponding to the quantity of bits is determined based on the transmission configuration information, and the data to be transmitted is transmitted based on the target transmission mode; where the target transmission mode includes any one of the following modes: performing data transmission by the UE based on the random access procedure, performing data transmission by the UE based on the transmission resource pre-configured by the network device, or performing data transmission by the UE after transitioning to the connected state. The amount of data which can be transmitted by the random access procedure is generally small, and the amount of data which is transmitted based on the transmission resource pre-configured by the network device depends on the size of the pre-configured resource, while the amount of data which is transmitted after the UE transitions to the connected state is generally not limited, that is, the described several target transmission modes are respectively suitable for transmitting data with different quantities of bits. Therefore, when the UE is in the idle state or the inactive state, and there exists data which needs to be transmitted, taking the quantity of bits of the data to be transmitted as a basis can facilitate the UE selecting an appropriate data transmission mode, and improve data transmission efficiency.

Based on contents which are described in the foregoing embodiments, referring to FIG. 5, FIG. 5 is a second schematic flowchart of a data transmission method provided by an embodiment of the present disclosure, and an execution body of the embodiment is a UE in the embodiment shown in FIG. 1. As shown in FIG. 5, the method includes the following.

S501: acquire transmission configuration information from a network device.

In a feasible implementation, the UE receives a radio resource control (RRC) release message from the network device, and the RRC release message includes the transmission configuration information.

In an embodiment, the network may transition the UE to an idle state or an inactive state by using the RRC release message, the above transmission configuration information may be configured in the RRC release message, and the transmission configuration information of each UE may be different.

In another feasible implementation, the UE receives a system information block (System Information Block, SIB) from the network device, and the SIB includes the transmission configuration information.

In an embodiment, the UE in the idle state or the inactive state may perform cell selection or reselection based on cell measurement and reselection parameters, and reside in a cell. After the cell reselection to a new cell, the UE needs to read an SIB to obtain relevant information about the cell, where the transmission configuration information is configured in the SIB.

S502: determine the quantity of bits of data to be transmitted in the UE.

S503: determine a target transmission mode corresponding to the quantity of bits based on the transmission configuration information, where the target transmission mode includes any one of the following modes: performing data transmission by the UE based on a random access procedure, performing data transmission by the UE based on a transmission resource pre-configured by a network device, or performing data transmission by the UE after transitioning to a connected state.

S504: transmit the data to be transmitted based on the target transmission mode.

That is, in the embodiment of the present disclosure, after the UE acquires the transmission configuration information from the network device, when the UE is in the idle state or the inactive state, and there exists data which needs to be transmitted, the target transmission mode corresponding to the quantity of bits of the data to be transmitted can be determined based on the transmission configuration information, and the data to be transmitted is transmitted based on the target transmission mode. The network device may flexibly configure the transmission configuration information based on a requirement of data transmission, so that the UE can select a reasonable data transmission mode to perform data transmission.

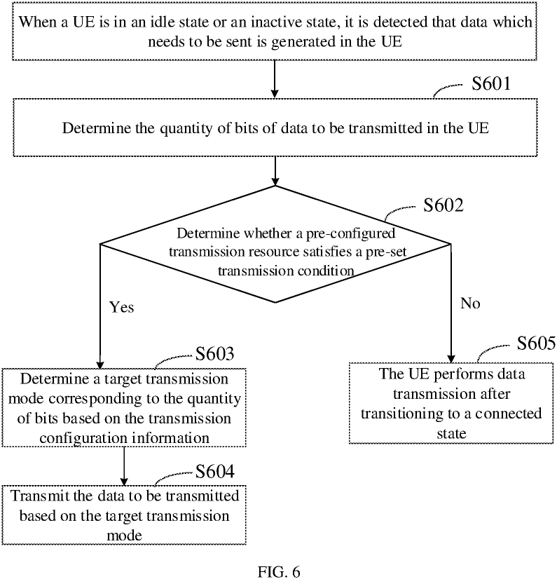

Based on the contents which are described in the foregoing embodiments, referring to FIG. 6, FIG. 6 is a third schematic flowchart of a data transmission method provided by an embodiment of the present disclosure.

When a UE is in an idle state or an inactive state, if it is detected that data which needs to be sent is generated in the UE, the data transmission method includes the following.

S601: determine the quantity of bits of data to be transmitted in the UE.

S602: determine whether a pre-configured transmission resource satisfies a pre-set transmission condition; when the pre-configured transmission resource satisfies the pre-set transmission condition, execute steps S603 to S604; otherwise, execute step S605.

Steps S601 and S602 may be implemented in parallel.

In an embodiment, the pre-set transmission condition is any one or more of the following transmission conditions.

I. the pre-configured transmission resource is associated with a service corresponding to the data to be transmitted.

It can be understood that, when the UE runs different application programs, services corresponding thereto are also different. After the UE establishes an RRC connection in an access network and completes authentication, one or more data radio bearers (Data Radio Bearer, DRB) may be established based on a requirement of a service. For each DRB, the UE may report characteristics of each service, for example parameters, such as a period of data packet generation, a time offset of data packet generation (a starting time within a period), the size of a data packet, through a UE auxiliary information message, so that the network device pre-configures a transmission resource corresponding to each DRB for the UE in advance, or the network device pre-configures one transmission resource corresponding to a plurality of DRBs for the UE in advance. It should be particularly noted that, the network device may pre-configure, based on a logic channel which bears a DRB, a corresponding transmission resource.

If the pre-configured transmission resource is inconsistent with the transmission resource pre-configured for the DRB corresponding to the data to be transmitted, it may be considered that the pre-configured transmission resource is not associated with the service corresponding to the data to be transmitted. In this case, the UE cannot transmit the data to be transmitted based on the pre-configured transmission resource.

In an embodiment, when the pre-configured transmission resource is not associated with the service corresponding to the data to be transmitted, the UE may select to transmit the data to be transmitted after transitioning to the connected state.

II. an interval duration between a starting moment of a time domain of the pre-configured transmission resource and a generating moment of the data to be transmitted is smaller than a pre-set duration.

It can be understood that, after the data to be transmitted is generated in the UE, when the interval duration between the generating moment of the data to be transmitted and the starting moment of the time domain of the pre-configured transmission resource is long, if the UE still uses the transmission resource to perform data transmission, the UE needs to wait for a long time until the data to be transmitted can be transmitted, which inevitably causes a large delay of the data transmission, thereby affecting user experience.

In an embodiment, when the interval duration between the starting moment of the time domain of the pre-configured transmission resource and the generating moment of the data to be transmitted is greater than or equal to the pre-set duration, the UE can select to transmit the data to be transmitted after transitioning to the connected state.

III. a serving cell corresponding to the pre-configured transmission resource is a serving cell where the UE currently resides.

It can be understood that, the UE can transmit data using the transmission resource only when the UE resides in the serving cell corresponding to the pre-configured transmission resource. Therefore, when the serving cell in which the UE currently resides is not the same as the serving cell corresponding to the pre-configured transmission resource, the UE cannot transmit the data to be transmitted based on the pre-configured transmission resource.

In an embodiment, when the serving cell where the UE currently resides is not the same as the serving cell corresponding to the pre-configured transmission resource, the UE may select to transmit the data to be transmitted after transitioning to the connected state.

IV. a serving cell corresponding to the pre-configured transmission resource is a serving cell where the UE currently resides, and the UE detects that signal quality of one or more beams corresponding to the transmission resource pre-configured by the network device exceeds a pre-set threshold.

When configuring a transmission resource, the network device may configure one or more beams corresponding to the transmission resource. A serving cell may have one or more beams, for example, a cell may have a plurality of SSBs, which are respectively represented by different SSB indexes. When the UE is in the serving cell, signals of one or more SSBs may be received. The network device usually does not apply the pre-configured transmission resource to all SSBs, since this will consume too many radio resources. The transmission resource which can be pre-configured by the network device corresponds to one or more SSBs, and only when the UE detects that the signal quality of the one or more SSBs exceeds the pre-set threshold, can an uplink data transmission be performed by using the pre-configured transmission resource.

V. a moving speed of the UE is lower than a pre-set speed threshold.

If the UE can determine its own moving speed, when the moving speed of the UE is very fast, adopting the pre-configured transmission resource cannot adapt to the rapid change of a wireless link, and therefore it is not suitable to adopt the pre-configured transmission resource to transmit the uplink data to be transmitted. Only when the moving speed of the UE is lower than the pre-set speed threshold, can the pre-configured transmission resource be applied.

In addition, if the network device has configured a timing advance (TA), then, when the TA is valid, steps S603 to S604 are executed; otherwise, step S605 is executed.

S603: determine a target transmission mode corresponding to the quantity of bits based on the transmission configuration information. The target transmission mode includes any one of the following modes: performing data transmission by the UE based on a random access procedure, performing data transmission by the UE based on a transmission resource pre-configured by the network device, or performing data transmission by the UE after transitioning to a connected state

S604: transmit the data to be transmitted based on the target transmission mode.

S605: the UE performs data transmission after transitioning to a connected state.

That is, in the embodiment of the present disclosure, when the UE is in the idle state or in the inactive state, if it is detected that data which needs to be sent is generated in the UE, the UE first determines whether the pre-configured transmission resource satisfies the pre-set transmission condition. If so, based on the quantity of bits of the data to be transmitted in the UE, the target transmission mode corresponding to the quantity of bits is determined based on the transmission configuration information. If not satisfied, it is indicated that the UE cannot use the pre-configured transmission resource currently, so data transmission is performed after the UE transitions to the connected state, thereby ensuring reliability of the data transmission.

Based on the contents which are described in the foregoing embodiments, in a feasible implementation of the present disclosure, the transmission configuration information includes a first threshold and a second threshold, and a transmission selection mode corresponding to the first threshold and the second threshold. The first threshold is smaller than the second threshold; and the transmission selection mode corresponding to the first threshold and the second threshold includes:
mode a: when the quantity of bits is smaller than the first threshold, the UE selects to perform data transmission based on the random access procedure;
mode b: when the quantity of bits is greater than or equal to the first threshold and smaller than the second threshold, the UE selects to perform data transmission based on the transmission resource pre-configured by the network device; and
mode c: when the quantity of bits is greater than or equal to the second threshold, the UE selects to perform data transmission after transitioning to the connected state.

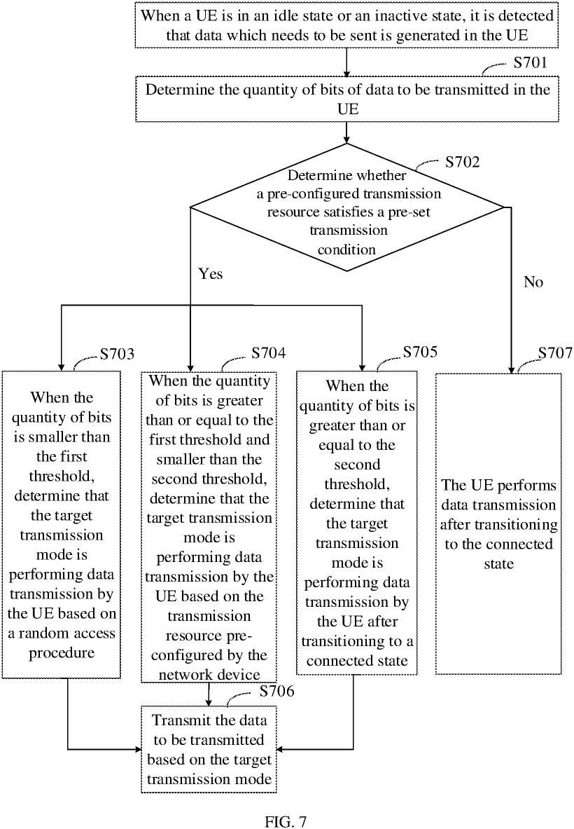

Referring to FIG. 7, FIG. 7 is a fourth schematic flowchart of a data transmission method provided by an embodiment of the present disclosure. In this implementation, when a UE is in an idle state or an inactive state, if it is detected that data which needs to be sent is generated in the UE, the data transmission method includes:
S701: determine the quantity of bits of data to be transmitted in the UE;
S702: determine whether a pre-configured transmission resource satisfies a pre-set transmission condition; and when the pre-configured transmission resource satisfies the pre-set transmission condition, execute steps S703 to S706; otherwise, execute step S707;
where steps S701 and S702 may be implemented in parallel;
S703: when the quantity of bits is smaller than the first threshold, determine that the target transmission mode is performing data transmission by the UE based on a random access procedure;
S704: when the quantity of bits is greater than or equal to the first threshold and smaller than the second threshold, determine that the target transmission mode is performing data transmission by the UE based on the transmission resource pre-configured by the network device;
S705: when the quantity of bits is greater than or equal to the second threshold, determine that the target transmission mode is performing data transmission by the UE after transitioning to a connected state;
S706: transmit the data to be transmitted based on the target transmission mode; and
S707: the UE performs data transmission after transitioning to the connected state.

It can be understood that, when the quantity of bits of the data to be transmitted is small, if the UE selects to perform data transmission based on the transmission resource pre-configured by the network device, a small amount of data transmission causes the UE to occupy the entire pre-configured transmission resource. However, the pre-configured transmission resource may be shared by a plurality of UEs, and the small amount of data occupying the entire pre-configured transmission resource may cause data transmission failure of other UEs, thereby affecting the spectrum efficiency of the entire communication system.

When the quantity of bits of the data to be transmitted is large and exceeds the maximum data amount which can be transmitted by the pre-configured transmission resource, data transmission failure can be caused, thereby affecting the reliability of data transmission.

In the embodiment of the present disclosure, the network device can reasonably configure the transmission configuration information based on the size of the transmission resource configured for the UE. When the quantity of bits of the data to be transmitted is relatively small, the UE selects to perform data transmission based on the random access procedure, which can avoid that the small amount of data transmission causes the UE to occupy the entire pre-configured transmission resource. When the quantity of bits of the data to be transmitted is relatively large, the UE selects to perform data transmission after transitioning to the connected state, thereby ensuring the reliability of the data transmission.

In the present embodiment, if the pre-configured transmission resource satisfies the pre-set transmission condition, it can be determined whether the quantity of bits of the data to be transmitted is smaller than the first threshold. When the quantity of bits of the data to be transmitted is smaller than the first threshold, the target transmission mode is determined to be performing data transmission by the UE based on the random access procedure. When the quantity of bits is greater than or equal to the first threshold, data transmission is performed after transition to the connected state. A process of the UE transitioning to the connected state belongs to an existing implementation, which is not described herein.

Based on the contents which are described in the foregoing embodiments, in another feasible implementation of the present disclosure, the transmission configuration information includes a first threshold and a transmission selection mode corresponding to the first threshold; where the transmission selection mode corresponding to the first threshold includes:
mode d: when the quantity of bits is smaller than the first threshold, the UE selects to perform data transmission based on the random access procedure; and
mode e: when the quantity of bits is greater than or equal to the first threshold, the UE selects to perform data transmission based on the transmission resource pre-configured by the network device.

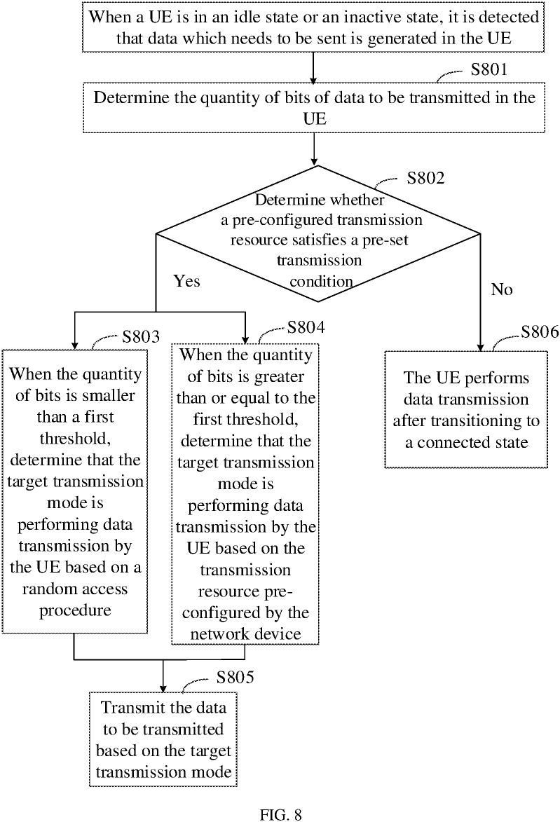

Referring to FIG. 8, FIG. 8 is a fifth schematic flowchart of a data transmission method provided by an embodiment of the present disclosure. In this implementation, when a UE is in an idle state or an inactive state, if it is detected that data which needs to be sent is generated in the UE, the data transmission method includes:
S801: determine the quantity of bits of data to be transmitted in the UE;
S802: determine whether a pre-configured transmission resource satisfies a pre-set transmission condition; when the pre-configured transmission resource satisfies the pre-set transmission condition, execute steps S803 to S805; otherwise, execute step S806;
in an embodiment, steps S801 and S802 may be implemented in parallel;
S803: when the quantity of bits is smaller than a first threshold, determine that the target transmission mode is performing data transmission by the UE based on a random access procedure;
S804: when the quantity of bits is greater than or equal to the first threshold, determine that the target transmission mode is performing data transmission by the UE based on the transmission resource pre-configured by the network device;
S805: transmit the data to be transmitted based on the target transmission mode; and
S806: the UE performs data transmission after transitioning to a connected state.

In the embodiment of the present disclosure, when the maximum data amount which can be transmitted by the transmission resource pre-configured by the network device for the UE can satisfy the maximum demand for a current service to be transmitted by the UE, and when the quantity of bits is smaller than the first threshold, the UE selects to perform data transmission based on the random access procedure. When the quantity of bits is greater than or equal to the first threshold, the UE selects to perform data transmission based on the transmission resource pre-configured by the network device. Thereby it can be avoided that the small amount of data transmission causes the UE to occupy the entire pre-configured transmission resource.

Based on the contents which are described in the foregoing embodiments, in still another feasible implementation of the present disclosure, the transmission configuration information includes a second threshold and a transmission selection mode corresponding to the second threshold; where the transmission selection mode corresponding to the second threshold includes:
mode g: when the quantity of bits is smaller than the second threshold, the UE selects to perform data transmission based on the transmission resource pre-configured by the network device; and
mode h: when the quantity of bits is greater than or equal to the second threshold, the UE selects to perform data transmission after transitioning to the connected state.

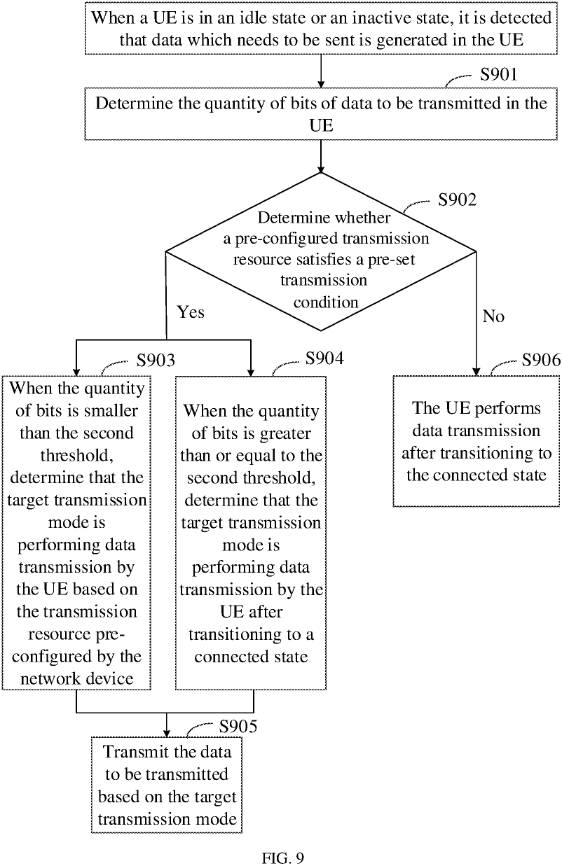

Referring to FIG. 9, FIG. 9 is a sixth schematic flowchart of a data transmission method provided by an embodiment of the present disclosure. In this implementation, when a UE is in an idle state or an inactive state, if it is detected that data which needs to be sent is generated in the UE, the data transmission method includes:
S901: determine the quantity of bits of data to be transmitted in the UE;
S902: determine whether a pre-configured transmission resource satisfies a pre-set transmission condition; when the pre-configured transmission resource satisfies the pre-set transmission condition, execute steps S903 to S905; otherwise, execute step S906;
in an embodiment, steps S901 and S902 may be implemented in parallel;
S903: when the quantity of bits is smaller than the second threshold, determine that the target transmission mode is performing data transmission by the UE based on the transmission resource pre-configured by the network device;
S904: when the quantity of bits is greater than or equal to the second threshold, determine that the target transmission mode is performing data transmission by the UE after transitioning to the connected state;
S905: transmit the data to be transmitted based on the target transmission mode; and
S906: the UE performs data transmission after transitioning to the connected state.

It can be understood that, when the quantity of bits of the data to be transmitted is relatively large and exceeds the maximum data amount which can be transmitted by the pre-configured transmission resource, data transmission failure may be caused, thereby affecting the reliability of data transmission.

In the embodiments of the present disclosure, the network device can reasonably configure the transmission configuration information based on the size of the transmission resource configured for the UE. When the quantity of bits of the data to be transmitted is relatively large, the UE selects to perform data transmission after transitioning to the connected state, thereby ensuring the reliability of data transmission.

Based on the contents which are described in the foregoing embodiments, the embodiments of the present disclosure further provide a data transmission method, which is applied to a UE, where the UE is in an idle state or an inactive state, and the method includes:
determining whether a transmission resource pre-configured by a network device in transmission configuration information satisfies a pre-set transmission condition;
when the pre-configured transmission resource satisfies the pre-set transmission condition, transmitting, by the UE, data to be transmitted based on the transmission resource pre-configured by the network device; and
when the pre-configured transmission resource does not satisfy the pre-set transmission condition, determining, by the UE, the quantity of bits of data to be transmitted; when the quantity of bits is smaller than a first threshold, transmitting, by the UE, the data to be transmitted based on a random access procedure; and when the quantity of bits is greater than or equal to the first threshold, transmitting, by the UE, the data to be transmitted after transitioning to a connected state.

In a feasible implementation, the pre-set transmission condition includes any one or more of the following transmission conditions:
the transmission resource pre-configured by the network device being associated with a service corresponding to the data to be transmitted;
an interval duration between a starting moment of a time domain of the transmission resource pre-configured by the network device and a generating moment of the data to be transmitted being smaller than a pre-set duration;
a serving cell corresponding to the transmission resource pre-configured by the network device being a serving cell where the UE currently resides; or
a serving cell corresponding to the transmission resource pre-configured by the network device being a serving cell where the UE currently resides, and the UE detecting that signal quality of one or more beams corresponding to the transmission resource pre-configured by the network device exceeds a pre-set threshold.

In the data transmission method provided by the embodiment of the present disclosure, when the UE is in the idle state or in the inactive state, if it is detected that data which needs to be transmitted is generated in the UE, the UE first determines whether the transmission resource pre-configured by the network device satisfies the pre-set transmission condition; if not, it is indicated that the UE cannot currently use the pre-configured transmission resource, and at this time, it can be determined whether the quantity of bits of the data to be transmitted in the UE is smaller than the first threshold. If the quantity of bits is smaller than the first threshold, the UE can perform data transmission based on the random access procedure. If the quantity of bits is greater than or equal to the first threshold, the UE can perform data transmission after transitioning to the connected state. Thereby it is possible to facilitate the UE selecting an appropriate data transmission mode.

Based on the contents which are described in the foregoing embodiments, the embodiments of the present disclosure further provide a data transmission method, which is applied to a network device.

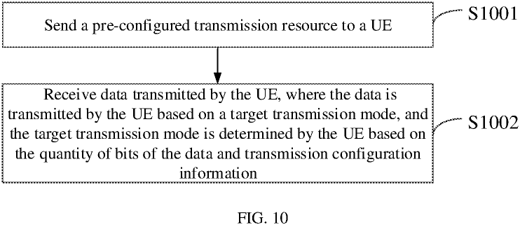

Referring to FIG. 10, FIG. 10 is a seventh schematic flowchart of a data transmission method provided by an embodiment of the present invention. The data transmission method includes:
S1001: send a pre-configured transmission resource to a UE; and
S1002: receive data transmitted by the UE, where the data is transmitted by the UE based on a target transmission mode, and the target transmission mode is determined by the UE based on the quantity of bits of the data and transmission configuration information, where the target transmission mode includes any one of the following modes: performing data transmission by the UE based on a random access procedure when in an idle state or an inactive state; performing data transmission by the UE based on the pre-configured transmission resource when in the idle state or the inactive state; or performing data transmission by the UE after transitioning from the idle state or the inactive state to a connected state.

In an embodiment, while sending the pre-configured transmission resource to the UE, the network device may also send the transmission configuration information to the UE.

In a feasible implementation, the network device sends an RRC release message to the UE, where the RRC release message includes the transmission configuration information.

In another possible implementation, the network device sends an SIB to the UE, where the SIB includes the transmission configuration information.

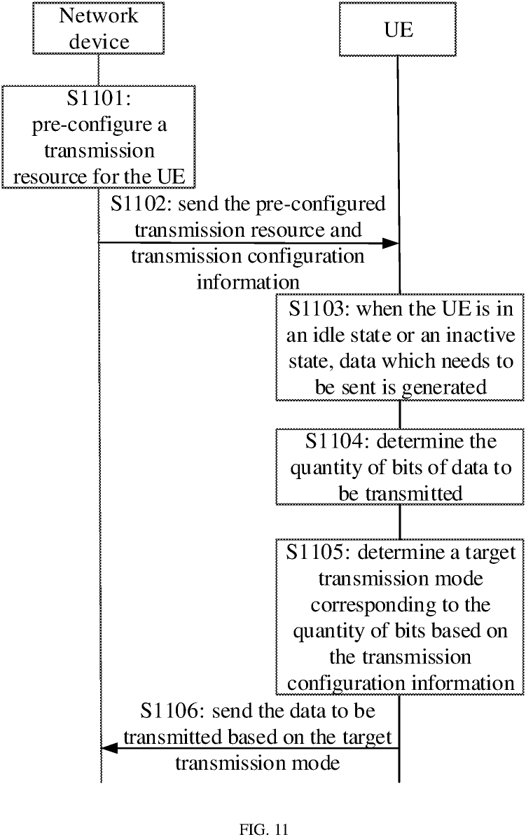

For a better understanding of the embodiments of the present disclosure, referring to FIG. 11, FIG. 11 is a schematic diagram of signaling interaction of a data transmission method provided by an embodiment of the present disclosure. In the embodiment of the present disclosure, the data transmission method includes:
S1101: the network device pre-configures a transmission resource for the UE;
S1102: the network device sends the pre-configured transmission resource and transmission configuration information to the UE;
S1103: when the UE is in an idle state or an inactive state, it is detected that data which needs to be sent is generated in the UE;
S1104: the UE determines the quantity of bits of data to be transmitted;
S1105: the UE determines a target transmission mode corresponding to the quantity of bits based on the transmission configuration information; and
S1106: the UE sends the data to be transmitted to the network device based on the target transmission mode.

In an embodiment, when the target transmission mode is performing data transmission by the UE based on the pre-configured transmission resource, the pre-configured transmission resource satisfies a pre-set transmission condition.

The preset transmission condition may be any one or more of the following transmission conditions:
the pre-configured transmission resource is associated with a service corresponding to the data to be transmitted;
an interval duration between a starting moment of a time domain of the pre-configured transmission resource and a generating moment of the data to be transmitted is smaller than a pre-set duration;
a serving cell corresponding to the pre-configured transmission resource is a serving cell where the UE currently resides;
a serving cell corresponding to the transmission resource pre-configured by the network device is a serving cell where the UE currently resides, and the UE detects that signal quality of one or more beams corresponding to the transmission resource pre-configured by the network device exceeds a pre-set threshold; or
a moving speed of the UE is lower than a pre-set speed threshold.

In a feasible implementation, the transmission configuration information includes a first threshold and a second threshold, and a transmission selection mode corresponding to the first threshold and the second threshold, where the first threshold is smaller than the second threshold, and the transmission selection mode corresponding to the first threshold and the second threshold includes:
when the quantity of bits is smaller than the first threshold, the UE selects to perform data transmission based on a random access procedure;
when the quantity of bits is greater than or equal to the first threshold and smaller than the second threshold, the UE selects to perform data transmission based on the transmission resource pre-configured by the network device; and
when the quantity of bits is greater than or equal to the second threshold, the UE selects to perform data transmission after transitioning to the connected state.

In another feasible implementation, the transmission configuration information includes a first threshold and a transmission selection mode corresponding to the first threshold; and the transmission selection mode corresponding to the first threshold includes:
when the quantity of bits is smaller than the first threshold, the UE selects to perform data transmission based on the random access procedure; and
when the quantity of bits is greater than or equal to the first threshold, the UE selects to perform data transmission based on the transmission resource pre-configured by the network device.

In still another feasible implementation, the transmission configuration information includes a second threshold and a transmission selection mode corresponding to the second threshold; and the transmission selection mode corresponding to the second threshold includes:
when the quantity of bits is smaller than the second threshold, the UE selects to perform data transmission based on the transmission resource pre-configured by the network device; and
when the described quantity of bits is greater than or equal to the second threshold, the UE selects to perform data transmission after transitioning to the connected state.

It can be understood that, implementation principles and manners of the data transmission method which is applied to the network device described in the foregoing embodiments are consistent with the data transmission method which is applied to the UE described in the foregoing embodiments. Reference can be made to the description of various embodiments of the data transmission method which is applied to the UE, which is not described herein again.

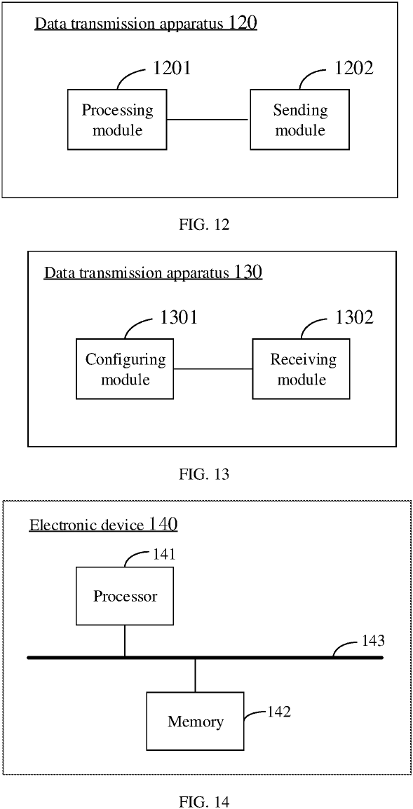

Further, based on the contents which are described in the foregoing embodiments, the embodiments of the present disclosure further provide a data transmission apparatus. The apparatus is applied to a UE shown in FIG. 1. Referring to FIG. 12, FIG. 12 is a first schematic module diagram of a data transmission apparatus provided by an embodiment of the present disclosure. The data transmission apparatus 120 includes:
a processing module 1201, configured to determine the quantity of bits of data to be transmitted in the UE;
the processing module 1201 is further configured to determine a target transmission mode corresponding to the quantity of bits based on transmission configuration information, where the target transmission mode includes any one of the following modes: performing data transmission by the UE based on a random access procedure, performing data transmission by the UE based on a transmission resource pre-configured by a network device, and performing data transmission by the UE after transitioning to a connected state; and
a sending module 1202, configured to transmit the data to be transmitted based on the target transmission mode.

In an embodiment, the transmission configuration information includes a first threshold, a second threshold greater than the first threshold, and a transmission selection mode corresponding to the first threshold and/or the second threshold; and the processing module 1201 is specifically configured to:
when the quantity of bits is smaller than the first threshold, determine that the target transmission mode is performing data transmission by the UE based on the random access procedure;
when the quantity of bits is greater than or equal to the first threshold and smaller than the second threshold, determine that the target transmission mode is performing data transmission by the UE based on the transmission resource pre-configured by the network device; and
when the quantity of bits is greater than or equal to the second threshold, determine that the target transmission mode is performing data transmission by the UE after transitioning to the connected state.

In an embodiment, the transmission configuration information includes a first threshold and a transmission selection mode corresponding to the first threshold; and the processing module 1201 is specifically configured to:
when the quantity of bits is smaller than the first threshold, determine that the target transmission mode is performing data transmission by the UE based on the random access procedure; and
when the quantity of bits is greater than or equal to the first threshold, determine that the target transmission mode is performing data transmission by the UE based on the transmission resource pre-configured by the network device.

In an embodiment, the transmission configuration information includes a second threshold and a transmission selection mode corresponding to the second threshold; and the processing module 1201 is specifically configured to:
when the quantity of bits is smaller than the second threshold, determine that the target transmission mode is performing data transmission by the UE based on the transmission resource pre-configured by the network device; and
when the quantity of bits is greater than or equal to the second threshold, determine that the target transmission mode is performing data transmission by the UE after transitioning to the connected state.

The processing module 1201 is further specifically configured to:
determine whether the transmission resource pre-configured by the network device satisfies a pre-set transmission condition; and
when the pre-configured transmission resource satisfies the pre-set transmission condition, determine that the target transmission mode is performing data transmission by the UE based on the transmission resource pre-configured by the network device.

In an embodiment, when the transmission resource pre-configured by the network device does not satisfy the pre-set transmission condition, the UE performs data transmission after transitioning to the connected state.

The processing module 1201 is further specifically configured to:
determine whether a moving speed of the UE is lower than a pre-set speed threshold; and
when the moving speed of the UE is lower than the pre-set speed threshold, determine that the target transmission mode is performing data transmission by the UE based on the transmission resource pre-configured by the network device.

In an embodiment, an acquiring module is further included, and the acquiring module is configured to acquire the transmission configuration information from the network device.

In an embodiment, the acquiring module is specifically configured to:
receive a radio resource control (RRC) release message from the network device, where the RRC release message includes the transmission configuration information; or,
receive a system information block (SIB) from the network device, where the SIB includes the transmission configuration information.

It can be understood that, the data transmission apparatus 120 is the same as the data transmission method applied to a UE described in the foregoing embodiments with regard to the implementation principles and manners. Reference can be made to the description of various embodiments in the foregoing data transmission method which is applied to the UE, which is not described herein again.

Further, based on the contents which are described in the foregoing embodiments, the embodiments of the present disclosure further provide a data transmission apparatus, and the apparatus includes:
a determining module, configured to determine whether a transmission resource pre-configured by a network device in transmission configuration information satisfies a pre-set transmission condition; and
a processing module, configured to: when the pre-configured transmission resource satisfies the pre-set transmission condition, transmit, by the UE, data to be transmitted based on the transmission resource pre-configured by the network device; when the pre-configured transmission resource does not satisfy the pre-set transmission condition, determine, by the UE, the quantity of bits of the data to be transmitted; when the quantity of bits is smaller than a first threshold, transmit, by the UE, the data to be transmitted based on a random access procedure; and when the quantity of bits is greater than or equal to the first threshold, transmit, by the UE, the data to be transmitted after transitioning to a connected state.

Further, based on the contents which are described in the foregoing embodiments, the embodiments of the present disclosure further provide a data transmission apparatus. The apparatus is applied to the network device shown in FIG. 1. Referring to FIG. 13, FIG. 13 is a second schematic module diagram of a data transmission apparatus provided by an embodiment of the present disclosure, and the data transmission apparatus 130 includes:
a configuring module 1301, configured to send a pre-configured transmission resource to a user equipment (UE); and
a receiving module 1302, configured to receive data transmitted by the UE, where the data is transmitted by the UE based on a target transmission mode, the target transmission mode is determined by the UE based on the quantity of bits of the data and transmission configuration information, and the target transmission mode includes any one of the following modes: performing data transmission by the UE based on a random access procedure when in an idle state or in an inactive state, performing data transmission by the UE based on the pre-configured transmission resource when in the idle state or the inactive state, or performing data transmission by the UE after transitioning from the idle state or the inactive state to a connected state.

In an embodiment, the transmission configuration information includes a first threshold, a second threshold greater than the first threshold, and a transmission selection mode corresponding to the first threshold and/or the second threshold; and the transmission selection mode corresponding to the first threshold and/or the second threshold includes:
when the quantity of bits is smaller than the first threshold, the UE selects to perform data transmission based on the random access procedure;
when the quantity of bits is greater than or equal to the first threshold and smaller than the second threshold, the UE selects to perform data transmission based on the transmission resource pre-configured by the network device; and
when the quantity of bits is greater than or equal to the second threshold, the UE selects to perform data transmission after transitioning to the connected state.

In an embodiment, the transmission configuration information includes a first threshold and a transmission selection mode corresponding to the first threshold; and the transmission selection mode corresponding to the first threshold includes:
when the quantity of bits is smaller than the first threshold, the UE selects to perform data transmission based on the random access procedure; and
when the quantity of bits is greater than or equal to the first threshold, the UE selects to perform data transmission based on the transmission resource pre-configured by the network device.

In an embodiment, the transmission configuration information includes a second threshold and a transmission selection mode corresponding to the second threshold; and the transmission selection mode corresponding to the second threshold includes:
when the quantity of bits is smaller than the second threshold, the UE selects to perform data transmission based on the transmission resource pre-configured by the network device; and
when the quantity of bits is greater than or equal to the second threshold, the UE selects to perform data transmission after transitioning to the connected state.

In an embodiment, when the target transmission mode is performing data transmission by the UE based on the pre-configured transmission resource, and the pre-configured transmission resource satisfies the pre-set transmission condition.

In an embodiment, the configuring module 1301 is further configured to:

send the transmission configuration information to the UE.

In an embodiment, the configuring module 1301 is further specifically configured to:
send a radio resource control (RRC) release message to the UE, where the RRC release message includes the transmission configuration information; or,
send a system information block (SIB) to the UE, where the SIB includes the transmission configuration information.

It can be understood that, the data transmission apparatus 130 is the same as the data transmission method which is applied to the network device described in the foregoing embodiments with regard to implementation principles and manners. Reference may be made to the description of various embodiments of the data transmission method which is applied to the network device, which is not described herein again.

In an embodiment, the foregoing apparatus can be a chip or a chip module.

Each module which is included in the data transmission apparatus described in the foregoing embodiments may be a software module, a hardware module, or a part being a software module while a part being a hardware module. For example, with regard to various apparatuses and products which are applied to or integrated in the chip, each module which is included therein may all be implemented by means of hardware, such as a circuit, or at least part of the modules may be implemented by means of a software program which runs on a processor integrated inside the chip, and the remaining (if any) part of the modules can be implemented by means of hardware, such as a circuit. With regard to various apparatuses and products which are applied to or integrated in the chip module, each module which is included therein may all be implemented by means of hardware, such as a circuit, different modules may be located in the same component (e.g., a chip, a circuit module, etc.) or different components of the chip component; or, at least part of the modules may be implemented by means of a software program which runs on a processor integrated within the chip module, and the remaining (if any) part of the modules may be implemented by hardware such as a circuit. With regard to various apparatuses and products which are applied to or integrated in a terminal, modules which are included therein may all be implemented by means of hardware such as a circuit, different modules may be located in the same component (for example, a chip, a circuit module, etc.) or different components in the terminal, or at least part of the modules may be implemented by using a software program which runs on a processor integrated inside the terminal, and the remaining (if any) part of the modules may be implemented by hardware such as the circuit.

Further, based on the contents which are described in the foregoing embodiments, the embodiments of the present disclosure further provide a user equipment. The user equipment includes at least one processor and a memory; the memory stores computer execution instructions; and the at least one processor executes the computer execution instructions stored in the memory, so as to implement the contents which are described in various embodiments of the foregoing data transmission method applied to the UE.

Further, based on the contents which are described in the foregoing embodiments, the embodiments of the present disclosure further provide a network device. The network device includes at least one processor and a memory; the memory stores computer execution instructions; and the at least one processor executes the computer execution instructions stored in the memory, so as to implement the contents which are described in various embodiments of the foregoing data transmission method applied to the network device.

The user equipment and the network device provided by the embodiments may be configured to execute technical solutions of the foregoing method embodiments, and implementation principles and technical effects thereof are similar, which are not repeatedly described herein in the embodiments.

For a better understanding of the embodiments of the present disclosure, referring to FIG. 14. FIG. 14 is a schematic structural diagram of hardware of an electronic device provided by an embodiment of the present disclosure. The electronic device may be the foregoing user equipment, and may also be the foregoing network device.

As shown in FIG. 14, the electronic device 140 of the embodiment includes: a processor 1401 and a memory 1402, where:
the memory 1402 is configured to store computer execution instructions;
the processor 1401 is configured to execute the computer execution instructions stored in the memory, so as to implement various steps executed by the user equipment in the foregoing embodiments; or,
the processor 1401 is configured to execute the computer execution instructions stored in the memory, so as to implement various steps executed by the network device in the foregoing embodiments.

Reference can be made to the relevant description in the foregoing method embodiments.

In an embodiment, the memory 1402 may be independent from or integrated with the processor 1401.

When the memory 1402 is independently disposed, the device further includes a bus 1403, which is configured to connect the memory 1402 and the processor 1401.

Embodiments of the present disclosure provide a computer readable storage medium. The computer readable storage medium stores computer execution instructions therein. When a processor executes the computer execution instructions, various steps executed by the user equipment in the foregoing embodiments are implemented.

Embodiments of the present disclosure further provide a computer readable storage medium. The computer readable storage medium stores computer execution instructions therein. When a processor executes the computer execution instructions, various steps executed by the network device in the foregoing embodiments are implemented.

In the several embodiments provided in the present disclosure, it should be understood that, the disclosed device and method may be implemented in other manners. For example, the foregoing described device embodiments are merely illustrative. For example, the division of the modules is a merely logical function division, and may be other divisions in actual implementations. For example, a plurality of modules may be combined or integrated into another system, or some features may be ignored or not executed. In addition, the displayed or discussed mutual couplings or direct couplings or communication connections may be indirect couplings or communication connections through some interfaces, apparatuses or modules, and may be in electrical, mechanical, or other forms.

The modules which are described as separate parts may or may not be physically separate, and parts which are displayed as modules may or may not be physical units, that is, may be located in one position, or may be distributed on a plurality of network units. A part or all of the modules may be selected based on actual needs to achieve the objectives of the solutions of the embodiments.

In addition, each function modules in various embodiments of the present disclosure may be integrated into one processing unit, or each module can exist alone physically, or two or more modules may be integrated into one unit. The foregoing modules may be implemented in a form of hardware, and may also be implemented in a form of hardware plus a software functional unit.

The above integrated modules which are implemented in the form of the software functional modules may be stored in a computer readable storage medium. The above software function modules are stored in a storage medium, and includes several instructions for instructing a computer device (which can be a personal computer, a server, or a network device, etc.) or a processor to execute a part of the steps of the method which is described in various embodiments of the present disclosure.

It should be understood that the foregoing processor may be a central processing unit (CPU), and may also be other general processors, a digital signal processor (DSP), an application specific integrated circuit (ASIC), and the like. The general processor may be a microprocessor, or the processor may also be any processor. The steps of the methods which are disclosed in the disclosure may be directly embodied as being completed by a hardware processor, or may be completed by a combination of hardware and software modules in the processor.

The memory may include a high-speed RAM memory, and may also include a non-volatile memory (NVM), for example, at least one magnetic disk memory, and may also be a USB disk, a removable hard disk, a read-only memory, a magnetic disk, or an optical disk, etc.

The bus may be an industry standard architecture (ISA) bus, a peripheral component interconnect (PCI) bus, or an extended industry standard architecture (EISA) bus, and the like. The bus may be classified into an address bus, a data bus, a control bus, and the like. For ease of representation, the bus in the drawings of the present disclosure is not limited to only one bus or one type of bus.

The foregoing storage medium may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk. The storage medium may be any available media which can be accessed by a general purpose or special purpose computer.

An illustrative storage medium is coupled to the processor such that the processor can read information from, and write information to, the storage medium. Certainly, the storage medium may also be a component of the processor, and the processor and the storage medium may be located in an application specific integrated circuit (ASIC). Certainly, the processor and the storage medium may also exist in an electronic device or a main control device as discrete components.

A person of ordinary skill in the art can understand that, all or a part of the steps of the method embodiments may be implemented by a program instructing relevant hardware. The foregoing program may be stored in the computer readable storage medium. When the program runs, the steps of the foregoing method embodiments are executed. The foregoing storage medium may be any medium which is capable of storing program codes, such as a ROM, a RAM, a magnetic disk, or an optical disk, etc.

Embodiments of the present application provide a data transmission method and device, so as to solve a technical problem in the prior art that it is difficult to reasonably select a data transmission mode when a UE is not in a connected state.

In a first aspect, embodiments of the present application provide a data transmission method, applied to a UE, where the UE is in an idle state or an inactive state, and the method includes:
determining the quantity of bits of data to be transmitted in the UE;
determining a target transmission mode corresponding to the quantity of bits based on transmission configuration information, where the target transmission mode includes any one of the following modes: performing data transmission by the UE based on a random access procedure, performing data transmission by the UE based on a transmission resource pre-configured by a network device, or performing data transmission by the UE after transitioning to a connected state; and
transmitting the data to be transmitted based on the target transmission mode.

In a feasible implementation, the transmission configuration information includes a first threshold, a second threshold greater than the first threshold, and a transmission selection mode corresponding to the first threshold and/or the second threshold; and the determining the target transmission mode corresponding to the quantity of bits based on the transmission configuration information includes:
when the quantity of bits is smaller than the first threshold, determining that the target transmission mode is performing data transmission by the UE based on the random access procedure;
when the quantity of bits is greater than or equal to the first threshold and smaller than the second threshold, determining that the target transmission mode is performing data transmission by the UE based on the transmission resource pre-configured by the network device; and
when the quantity of bits is greater than or equal to the second threshold, determining that the target transmission mode is performing data transmission by the UE after transitioning to the connected state.

In a feasible implementation, the transmission configuration information includes a first threshold and a transmission selection mode corresponding to the first threshold; and the determining the target transmission mode corresponding to the quantity of bits based on the transmission configuration information includes:
when the quantity of bits is smaller than the first threshold, determining that the target transmission mode is performing data transmission by the UE based on the random access procedure; and
when the quantity of bits is greater than or equal to the first threshold, determining that the target transmission mode is performing data transmission by the UE based on the transmission resource pre-configured by the network device.

In a feasible implementation, the transmission configuration information includes a second threshold and a transmission selection mode corresponding to the second threshold; and the determining the target transmission mode corresponding to the quantity of bits based on the transmission configuration information includes:
when the quantity of bits is smaller than the second threshold, determining that the target transmission mode is performing data transmission by the UE based on the transmission resource pre-configured by the network device; and
when the quantity of bits is greater than or equal to the second threshold, determining that the target transmission mode is performing data transmission by the UE after transitioning to the connected state.

In a feasible implementation, the determining that the target transmission mode is performing data transmission by the UE based on the transmission resource pre-configured by the network device includes:
determining whether the transmission resource pre-configured by the network device satisfies a pre-set transmission condition; and
when the pre-configured transmission resource satisfies the pre-set transmission condition, determining that the target transmission mode is performing data transmission by the UE based on the transmission resource pre-configured by the network device.

In a feasible implementation, there further includes:

when the transmission resource pre-configured by the network device does not satisfy the pre-set transmission condition, performing, by the UE, data transmission after transitioning to the connected state.

In a feasible implementation, the pre-set transmission condition includes any one or more of the following transmission conditions:
the transmission resource pre-configured by the network device being associated with a service corresponding to the data to be transmitted;
an interval duration between a starting moment of a time domain of the transmission resource pre-configured by the network device and a generating moment of the data to be transmitted being smaller than a pre-set duration;
a serving cell corresponding to the transmission resource pre-configured by the network device being a serving cell where the UE currently resides; or
a serving cell corresponding to the transmission resource pre-configured by the network device being a serving cell where the UE currently resides, and the UE detecting that signal quality of one or more beams corresponding to the transmission resource pre-configured by the network device exceeds a pre-set threshold.

In a feasible implementation, the determining that the target transmission mode is performing data transmission by the UE based on the transmission resource pre-configured by the network device includes:
determining whether a moving speed of the UE is lower than a pre-set speed threshold; and
when the moving speed of the UE is lower than the pre-set speed threshold, determining that the target transmission mode is performing data transmission by the UE based on the transmission resource pre-configured by the network device.

In a feasible implementation, there further includes:
acquiring the transmission configuration information from the network device.

In a feasible implementation, the acquiring the transmission configuration information from the network device includes:
receiving a radio resource control (Radio Resource Control, RRC) release message from the network device, where the RRC release message includes the transmission configuration information.

In a feasible implementation, the acquiring the transmission configuration information from the network device includes:
receiving a system information block (System Information Block, SIB) from the network device, where the SIB includes the transmission configuration information.

In a second aspect, embodiments of the present application provide a data transmission method, applied to a UE, where the UE is in an idle state or an inactive state, and the method includes:
determining whether a transmission resource pre-configured by a network device in transmission configuration information satisfies a pre-set transmission condition;
when the pre-configured transmission resource satisfies the pre-set transmission condition, transmitting, by the UE, data to be transmitted based on the transmission resource pre-configured by the network device; and
when the pre-configured transmission resource does not satisfy the pre-set transmission condition, determining, by the UE, the quantity of bits of the data to be transmitted; when the quantity of bits is smaller than a first threshold, transmitting, by the UE, the data to be transmitted based on a random access procedure; and when the quantity of bits is greater than or equal to the first threshold, transmitting, by the UE, the data to be transmitted after transitioning to a connected state.

In a feasible implementation, the pre-set transmission condition includes any one or more of the following transmission conditions:
the transmission resource pre-configured by the network device being associated with a service corresponding to the data to be transmitted;
an interval duration between a starting moment of a time domain of the transmission resource pre-configured by the network device and a generating moment of the data to be transmitted being smaller than a pre-set duration;
a serving cell corresponding to the transmission resource pre-configured by the network device being a serving cell where the UE currently resides; or
a serving cell corresponding to the transmission resource pre-configured by the network device being a serving cell where the UE currently resides, and the UE detecting that signal quality of one or more beams corresponding to the transmission resource pre-configured by the network device exceeds a pre-set threshold.

In a third aspect, embodiments of the present application provide a data transmission method, applied to a network device, and the method includes:
sending a pre-configured transmission resource to a UE; and
receiving data transmitted by the UE, where the data is transmitted by the UE based on a target transmission mode, the target transmission mode is determined by the UE based on the quantity of bits of the data and transmission configuration information, and the target transmission mode includes any one of the following modes: performing data transmission by the UE based on a random access procedure when in an idle state or an inactive state, performing data transmission by the UE based on a pre-configured transmission resource when in the idle state or the inactive state, and performing data transmission by the UE after transitioning from the idle state or the inactive state to a connected state.

In a feasible implementation, the transmission configuration information includes a first threshold, a second threshold greater than the first threshold, and a transmission selection mode corresponding to the first threshold and/or the second threshold; and the transmission selection mode corresponding to the first threshold and/or the second threshold includes:
when the quantity of bits is smaller than the first threshold, the UE selecting to perform data transmission based on the random access procedure;
when the quantity of bits is greater than or equal to the first threshold and smaller than the second threshold, the UE selecting to perform data transmission based on the transmission resource pre-configured by the network device; and
when the quantity of bits is greater than or equal to the second threshold, the UE selecting to perform data transmission after transitioning to the connected state.

In a feasible implementation, the transmission configuration information includes a first threshold and a transmission selection mode corresponding to the first threshold; and the transmission selection mode corresponding to the first threshold includes:
when the quantity of bits is smaller than the first threshold, the UE selecting to perform data transmission based on the random access procedure; and
when the quantity of bits is greater than or equal to the first threshold, the UE selecting to perform data transmission based on the transmission resource pre-configured by the network device.

In a feasible implementation, the transmission configuration information includes a second threshold and a transmission selection mode corresponding to the second threshold; and the transmission selection mode corresponding to the second threshold includes:
when the quantity of bits is smaller than the second threshold, the UE selecting to perform data transmission based on the transmission resource pre-configured by the network device; and
when the quantity of bits is greater than or equal to the second threshold, the UE selecting to perform data transmission after transitioning to the connected state.

In a feasible implementation, when the target transmission mode is performing data transmission by the UE based on the pre-configured transmission resource, the pre-configured transmission resource satisfies a pre-set transmission condition.

In a feasible implementation, the preset transmission condition is any one or more of the following transmission conditions:
the pre-configured transmission resource being associated with a service corresponding to the data to be transmitted;
an interval duration between a starting moment of a time domain of the pre-configured transmission resource and a generating moment of the data to be transmitted being smaller than a pre-set duration;
a serving cell corresponding to the pre-configured transmission resource being a serving cell where the UE currently resides; or
a serving cell corresponding to the pre-configured transmission resource being a serving cell where the UE currently resides, and the UE detecting that signal quality of one or more beams corresponding to the transmission resource pre-configured by the network device exceeds a pre-set threshold.

In a feasible implementation, there further includes:
sending the transmission configuration information to the UE.

In a feasible implementation, the sending the transmission configuration information to the UE includes:
sending an RRC release message to the UE, where the RRC release message includes the transmission configuration information.

In a feasible implementation, the sending the transmission configuration information to the UE includes:
sending an SIB to the UE, where the SIB includes the transmission configuration information.

In a fourth aspect, embodiments of the present application provide a data transmission apparatus, applied to a UE, where the UE is in an idle state or an inactive state, and the apparatus includes:
a processing module, configured to determine the quantity of bits of data to be transmitted in the UE;
the processing module being further configured to determine a target transmission mode corresponding to the quantity of bits based on transmission configuration information, where the target transmission mode includes any one of the following modes: performing data transmission by the UE based on a random access procedure, performing data transmission by the UE based on a transmission resource pre-configured by a network device, or performing data transmission by the UE after transitioning to a connected state; and
a sending module, configured to transmit the data to be transmitted based on the target transmission mode.

In a fifth aspect, embodiments of the present application provide a data transmission apparatus, applied to a network device, where the apparatus includes:
a configuring module, configured to send a pre-configured transmission resource to a user equipment (UE); and
a receiving module, configured to receive data transmitted by the UE, where the data is transmitted by the UE based on a target transmission mode, and the target transmission mode is determined by the UE based on the quantity of bits of the data and transmission configuration information, where the target transmission mode includes any one of the following modes: performing data transmission by the UE based on a random access procedure when in an idle state or an inactive state, performing data transmission by the UE based on the pre-configured transmission resource when in the idle state or the inactive state, or performing data transmission by the UE after transitioning from the idle state or the inactive state to a connected state.

In a sixth aspect, embodiments of the present application provide a data transmission apparatus, applied to a UE, where the UE is in an idle state or an inactive state, and the apparatus includes:
a determining module, configured to determine whether a transmission resource pre-configured by a network device in transmission configuration information satisfies a pre-set transmission condition; and
a processing module, configured to transmit, by the UE, data to be transmitted based on the transmission resource pre-configured by the network device when the pre-configured transmission resource satisfies the pre-set transmission condition;
the processing module being further configured to, when the pre-configured transmission resource does not satisfy the pre-set transmission condition, determine, by the UE, the quantity of bits of the data to be transmitted; when the quantity of bits is smaller than a first threshold, transmit, by the UE, the data to be transmitted based on a random access procedure; and when the quantity of bits is greater than or equal to the first threshold, transmit, by the UE, the data to be transmitted after transition to a connected state.

In a seventh aspect, embodiments of the present application provide a user equipment, including: at least one processor and a memory;
the memory stores computer execution instructions; and
the at least one processor executes the computer execution instructions stored in the memory to cause the at least one processor to execute the data transmission method according to the first aspect or the second aspect.

In an eighth aspect, embodiments of the present application provide a network device, including: at least one processor and a memory;
the memory stores computer execution instructions; and
the at least one processor executes the computer execution instructions stored in the memory to cause the at least one processor to execute the data transmission method according to the third aspect.

In a ninth aspect, embodiments of the present application provide a computer readable storage medium, where the computer readable storage medium stores computer execution instructions therein, and when a processor executes the computer execution instructions, the data transmission method according to the first aspect or the second aspect is implemented.

In a tenth aspect, embodiments of the present application provide a computer readable storage medium, where the computer readable storage medium stores computer execution instructions therein, and when a processor executes the computer execution instructions, the data transmission method according to the third aspect is implemented.

In the data transmission method and device provided by the embodiments of the present application, when a UE is in an idle state or an inactive state, if data which needs to be transmitted is generated in the UE, the quantity of bits of the data to be transmitted in the UE is determined; then a target transmission mode corresponding to the described quantity of bits is determined based on the transmission configuration information, and the data to be transmitted is transmitted based on the target transmission mode; where the target transmission mode includes any one of the following modes: performing data transmission by the UE based on a random access procedure, performing data transmission by the UE based on a transmission resource pre-configured by a network device, or performing data transmission by the UE after transitioning to a connected state. The amount of data which can be transmitted by the random access procedure is generally small, and the amount of data which is transmitted based on the transmission resource pre-configured by the network device depends on the size of the pre-configured resource, while the amount of data which is transmitted after the UE transitions to the connected state is generally not limited, that is, the described several target transmission modes are respectively suitable for transmitting data with different quantities of bits. Therefore, when the UE is in the idle state or the inactive state, and there exists data which needs to be transmitted, taking the quantity of bits of the data to be transmitted as a basis can facilitate the UE selecting an appropriate data transmission mode.

Finally, it should be noted that, the foregoing embodiments are merely intended for describing the technical solutions of the present disclosure rather than limiting the present disclosure. Although the present disclosure is described in detail with reference to the foregoing embodiments, a person of ordinary skill in the art should understand that modifications may be made to the technical solutions described in the foregoing embodiments, or equivalent replacements may be made to some or all technical features thereof. However, these modifications or replacements do not make the essence of the corresponding technical solutions depart from the scope of the technical solutions of the embodiments of the present disclosure.

1. A data transmission method, applied to a user equipment (UE), wherein the UE is in an idle state or an inactive state, and the method comprises:
determining a quantity of bits of data to be transmitted in the UE;
determining a target transmission mode corresponding to the quantity of bits based on transmission configuration information, wherein the target transmission mode comprises any one of the following modes: performing data transmission by the UE based on a random access procedure, performing data transmission by the UE based on a transmission resource pre-configured by a network device, or performing data transmission by the UE after transitioning to a connected state; and
transmitting the data to be transmitted based on the target transmission mode.

2. The method according to claim 1, wherein the transmission configuration information comprises a first threshold, a second threshold greater than the first threshold, and a transmission selection mode corresponding to at least one of the first threshold or the second threshold; and the determining the target transmission mode corresponding to the quantity of bits based on the transmission configuration information comprises:
when the quantity of bits is smaller than the first threshold, determining that the target transmission mode is performing data transmission by the UE based on the random access procedure;
when the quantity of bits is greater than or equal to the first threshold and smaller than the second threshold, determining that the target transmission mode is performing data transmission by the UE based on the transmission resource pre-configured by the network device; and
when the quantity of bits is greater than or equal to the second threshold, determining that the target transmission mode is performing data transmission by the UE after transitioning to the connected state.

3. (canceled)

4. The method according to claim 1, wherein the transmission configuration information comprises a second threshold and a transmission selection mode corresponding to the second threshold; and the determining the target transmission mode corresponding to the quantity of bits based on the transmission configuration information comprises:
when the quantity of bits is smaller than the second threshold, determining that the target transmission mode is performing data transmission by the UE based on the transmission resource pre-configured by the network device; and
when the quantity of bits is greater than or equal to the second threshold, determining that the target transmission mode is performing data transmission by the UE after transitioning to the connected state.

5. The method according to claim 2, wherein the determining that the target transmission mode is performing data transmission by the UE based on the transmission resource pre-configured by the network device comprises:
determining whether the transmission resource pre-configured by the network device satisfies a pre-set transmission condition; and
when the pre-configured transmission resource satisfies the pre-set transmission condition, determining that the target transmission mode is performing data transmission by the UE based on the transmission resource pre-configured by the network device.

6. The method according to claim 5, further comprising:
when the transmission resource pre-configured by the network device does not satisfy the pre-set transmission condition, performing, by the UE, the data transmission after transitioning to the connected state.

7. The method according to claim 5, wherein the pre-set transmission condition comprises any one or more of the following transmission conditions:
the transmission resource pre-configured by the network device being associated with a service corresponding to the data to be transmitted;
an interval duration between a starting moment of a time domain of the transmission resource pre-configured by the network device and a generating moment of the data to be transmitted being smaller than a pre-set duration;
a serving cell corresponding to the transmission resource pre-configured by the network device being a serving cell where the UE currently resides; or
a serving cell corresponding to the transmission resource pre-configured by the network device being a serving cell where the UE currently resides, and the UE detecting that signal quality of one or more beams corresponding to the transmission resource pre-configured by the network device exceeds a pre-set threshold.

8. The method according to claim 2, wherein the determining that the target transmission mode is performing data transmission by the UE based on the transmission resource pre-configured by the network device comprises:
determining whether a moving speed of the UE is lower than a pre-set speed threshold; and
when the moving speed of the UE is lower than the pre-set speed threshold, determining that the target transmission mode is performing data transmission by the UE based on the transmission resource pre-configured by the network device.

9. The method according to claim 1, further comprising:
acquiring the transmission configuration information from the network device.

10. The method according to claim 9, wherein the acquiring the transmission configuration information from the network device comprises:
receiving a radio resource control (RRC) release message from the network device, wherein the RRC release message comprises the transmission configuration information.

11. The method according to claim 9, wherein the acquiring the transmission configuration information from the network device comprises:
receiving a system information block (SIB) from the network device, wherein the SIB comprises the transmission configuration information.

12. A data transmission method, applied to a user equipment (UE), wherein the UE is in an idle state or an inactive state, and the method comprises:
determining whether a transmission resource pre-configured by a network device in transmission configuration information satisfies a pre-set transmission condition;
when the pre-configured transmission resource satisfies the pre-set transmission condition, transmitting, by the UE, data to be transmitted based on the transmission resource pre-configured by the network device; and
when the pre-configured transmission resource does not satisfy the pre-set transmission condition, determining, by the UE, a quantity of bits of the data to be transmitted; when the quantity of bits is smaller than a first threshold, transmitting, by the UE, the data to be transmitted based on a random access procedure; and when the quantity of bits is greater than or equal to the first threshold, transmitting, by the UE, the data to be transmitted after transitioning to a connected state.

13. The method according to claim 12, wherein the pre-set transmission condition comprises any one or more of the following transmission conditions:
the transmission resource pre-configured by the network device being associated with a service corresponding to the data to be transmitted;
an interval duration between a starting moment of a time domain of the transmission resource pre-configured by the network device and a generating moment of the data to be transmitted being smaller than a pre-set duration;
a serving cell corresponding to the transmission resource pre-configured by the network device being a serving cell where the UE currently resides; or
a serving cell corresponding to the transmission resource pre-configured by the network device being a serving cell where the UE currently resides, and the UE detecting that signal quality of one or more beams corresponding to the transmission resource pre-configured by the network device exceeds a pre-set threshold.

14-25. (canceled)

26. A user equipment, comprising: at least one processor and a memory;
the memory stores computer execution instructions; and
the at least one processor executes the computer execution instructions stored in the memory to cause the at least one processor to execute the data transmission method according to claim 1 .

27. (canceled)

28. A non-transitory computer readable storage medium, wherein the computer readable storage medium stores computer execution instructions therein, and when a processor executes the computer execution instructions, the data transmission method according to claim 12 is implemented.

29. (canceled)

30. A data transmission method, applied to a user equipment (UE), wherein the UE is in an idle state or an inactive state, and the method comprises:
determining a quantity of bits of data to be transmitted in the UE;
determining whether the quantity of bits of the data to be transmitted is smaller than a second threshold and whether a pre-configured transmission resource satisfies a pre-set transmission condition; and
when the quantity of bits of the data to be transmitted is smaller than the second threshold, and the pre-configured transmission resource satisfies the pre-set transmission condition, performing data transmission based on the pre-configured transmission resource;
wherein the pre-set transmission condition comprises at least one of: a serving cell corresponding to the pre-configured transmission resource being a serving cell where the UE currently resides, or, signal quality of one or more beams corresponding to the pre-configured transmission resource exceeding a pre-set threshold.

31. The method according to claim 30, wherein the pre-set transmission condition further comprises: the pre-configured transmission resource being associated with a service corresponding to the data to be transmitted.

32. The method according to claim 30, further comprising:
acquiring transmission configuration information from a network device, wherein the transmission configuration information comprises the pre-configured transmission resource.

33. The method according to claim 32, wherein the acquiring the transmission configuration information from the network device comprises:
receiving a radio resource control (RRC) release message from the network device, wherein the RRC release message comprises the transmission configuration information.

34. The method according to claim 32, wherein the acquiring the transmission configuration information from the network device comprises:
receiving a system information block (SIB) from the network device, wherein the SIB comprises the transmission configuration information.

35. A user equipment, comprising: at least one processor and a memory;
the memory stores computer execution instructions; and
the at least one processor executes the computer execution instructions stored in the memory to cause the at least one processor to execute the data transmission method according to claim 30.
